(19) United States
(12) Patent Application Publication
(10) Pub. No.: US 2025/0093104 A1
(43) Pub. Date: Mar. 20, 2025

(54) FURNACE TUBE POSITIONING SEAT

(71) Applicants: AACHEN Plastic Equipment Co., Ltd., Qionglin Township (TW); JINYUAN INTERNATIONAL TECHNOLOGY CO., LTD., Taipei City (TW)

(72) Inventors: Yung-Ching HSIEH, Taipei City (TW); Ming-Chun HSIEH, Qionglin Township, Hsinchu County (TW)

(21) Appl. No.: 18/786,320

(22) Filed: Jul. 26, 2024

(30) Foreign Application Priority Data
Sep. 18, 2023 (TW) 112135510

(51) Int. Cl. F27D 5/00

(52) U.S. Cl. CPC F27D 5/005

(57) ABSTRACT

A furnace tube positioning seat includes a base and at least one shock-absorbing structure. The base has at least one round groove that extends in a groove-extending direction for allowing at least a portion of the furnace tube to be received therein. The at least one shock-absorbing structure includes a connecting member and a shock-absorbing member. The connecting member protrudes outwardly from a groove defining wall of the base which defines the round groove. The shock-absorbing member includes a shock-absorbing strip that is adapted for allowing the furnace tube to lean thereagainst, and two clamping strips that extend respectively from two opposite sides of the shock-absorbing strip in the groove-extending direction. The shock-absorbing strip and the clamping strips cooperatively define an insertion groove that allows the connecting member to be removably inserted therein.

### CROSS-REFERENCE TO RELATED APPLICATION

This application claims priority to Taiwanese Invention Patent Application No. 112135510, filed on Sep. 18, 2023, the entire disclosure of which is incorporated by reference herein.

### FIELD

This disclosure relates to a positioning seat, and more particularly to a furnace tube positioning seat.

### BACKGROUND

Conventionally, a furnace tube is kept in a storage cabinet where a positioning seat is mounted for keeping the furnace tube from moving so that the furnace tube is kept vertically or horizontally in the storage cabinet. The furnace tube is usually made of quartz, which is fragile. In order to prevent the furnace tube from being scratched or cracking due to contact or collision with the positioning seat, the positioning seat is generally provided with a shock-absorbing pad that is attached to a surface thereof. However, the shock-absorbing pad is generally attached to the surface of the positioning seat by adhesives, so the shock-absorbing pad may fall off or shift in position, which makes placement of the furnace tube unstable.

### SUMMARY

Therefore, an object of the disclosure is to provide a furnace tube positioning seat that can alleviate at least one of the drawbacks of the prior art.

According to the disclosure, the furnace tube positioning seat is adapted for positioning at least one furnace tube, and includes a base and at least one shock-absorbing structure. The base has at least one round groove that is formed in a surface of the base and that extends through two opposite sides of the base in a groove-extending direction for allowing at least a portion of the furnace tube to be received therein. The at least one shock-absorbing structure includes a connecting member and a shock-absorbing member. The connecting member extends in a curving direction that is transverse to the groove-extending direction and protrudes outwardly from a groove defining wall of the base that defines the round groove. The shock-absorbing member includes a shock-absorbing strip that is disposed on a side of the connecting member distal from the base and that is adapted for allowing the furnace tube to lean thereagainst, and two clamping strips that extend respectively from two opposite sides of the shock-absorbing strip in the groove-extending direction. The shock-absorbing strip and the clamping strips cooperatively define an insertion groove that allows the connecting member to be removably inserted therein to thereby allow the shock-absorbing member to be stably positioned in the round groove.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a top view illustrating an embodiment of a furnace tube positioning seat of the present disclosure, which is applied to a storage cabinet and a furnace tube.

FIG. 2 is a perspective view illustrating the embodiment.

FIG. 3 is an exploded perspective view illustrating the embodiment.

FIG. 4 is a fragmentary exploded perspective view corresponding to FIG. 3, illustrating details of the embodiment.

FIG. 5 is a sectional view taken along line V-V in FIG. 2, illustrating details of the embodiment.

FIG. 6 is a right side view illustrating another example of the embodiment of the present disclosure, which is applied to the storage cabinet and the furnace tube.

FIG. 7 is a perspective view illustrating the another example.

FIG. 8 is an exploded perspective view illustrating the another example.

FIG. 9 is a sectional view taken along line IX-IX in FIG. 7, illustrating details of the another example.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

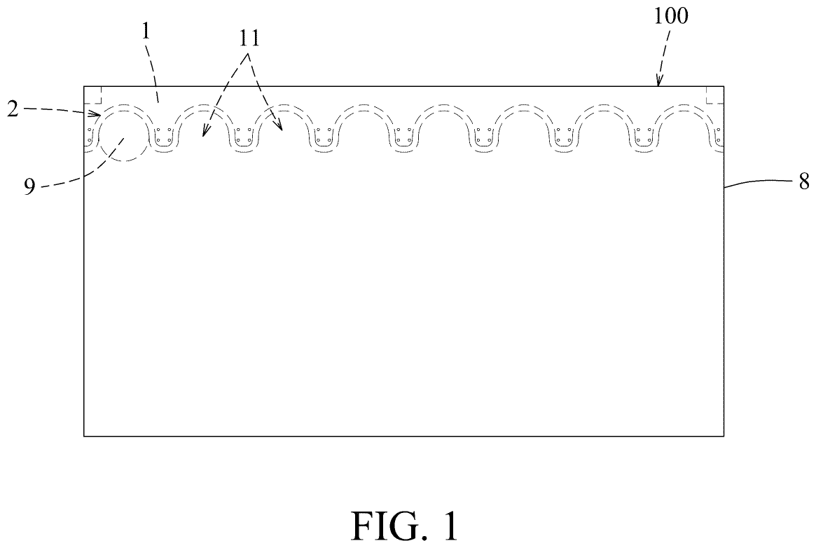

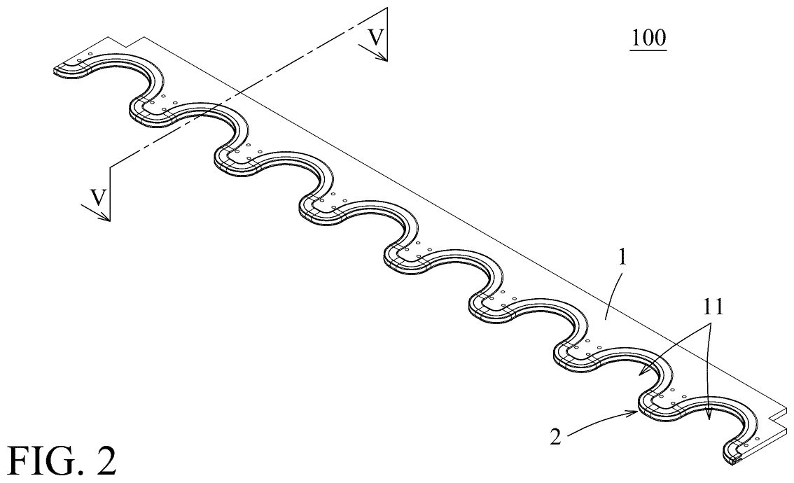

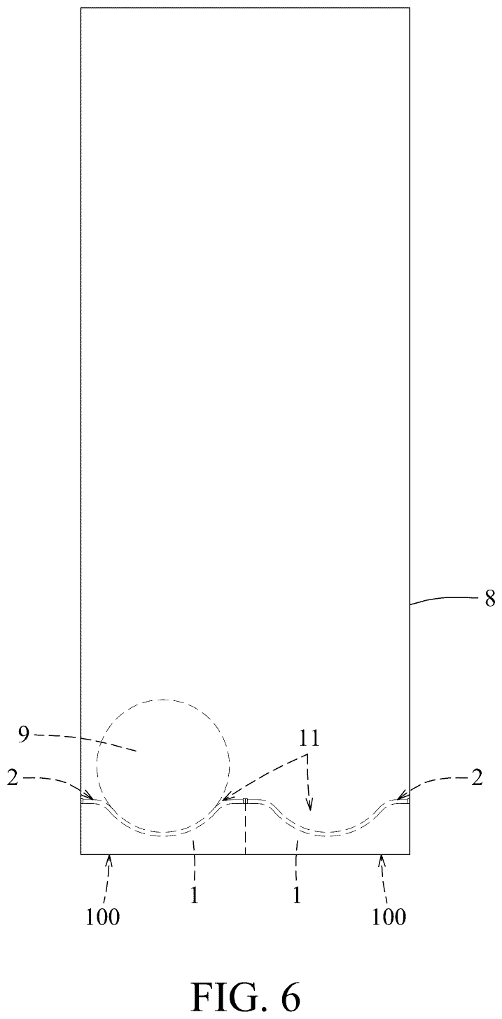

Referring to FIGS. 1 and 2, an embodiment of the furnace tube positioning seat 100 of the present disclosure is shown. The furnace tube positioning seat 100 is adapted to be mounted in a storage cabinet 8 for positioning at least one furnace tube 9, such that the furnace tube 9 is stored in the storage cabinet 8. In an example of this embodiment, as shown in FIG. 1, the number of the furnace tube positioning seat 100 is exemplified as one. The furnace tube positioning seat 100 is adapted to be mounted on a rear side of an inner wall of the storage cabinet 8, and is adapted for positioning a plurality of furnace tubes 9 that are disposed vertically and are spaced apart from each other in a horizontal direction. In another example of the embodiment, as shown in FIG. 6, the number of the furnace tube positioning seat 100 is exemplified as two, and the two furnace tube positioning seats 100 are mounted on a bottom wall of the storage cabinet 8 and are arranged in a rear-front direction. Each of the furnace tube positioning seats 100 is adapted for positioning one end of the furnace tube 9 that is disposed horizontally. It should be noted that the number and position of the furnace tube positioning seat 100 to be disposed in the storage cabinet 8 and the number of the furnace tube 9 to be positioned by the furnace tube positioning seat 100 are not limited to those stated in the embodiment.

Referring again to FIGS. 1 and 2, the furnace tube positioning seat 100 includes a base 1 and at least one shock-absorbing structure 2. The base 1 has at least one round groove 11 that is formed in a surface of the base 1 and that extends through two opposite sides of the base 1 in a groove-extending direction (X) for allowing at least a portion of the furnace tube 9 (e.g., a half circle or a whole circle of an outer periphery of the furnace tube 9) to be received therein. In this embodiment, for example, the base 1 has a plurality of the round grooves 11 for respectively and vertically positioning a plurality of the furnace tubes 9 (only one is shown in the figures). Specifically, the round grooves 11 are formed in a lateral surface of the base 1 to be spaced apart from each other in the horizontal direction and extends through top and bottom sides of the base 1. The number of the round grooves 11 may be only one, and is not limited thereto. In this embodiment, the base 1 is a thin plate extending in the horizontal direction. In some embodiments, the base 1 may be an elongated block. The shape of the base 1 is not limited to any specific shape.

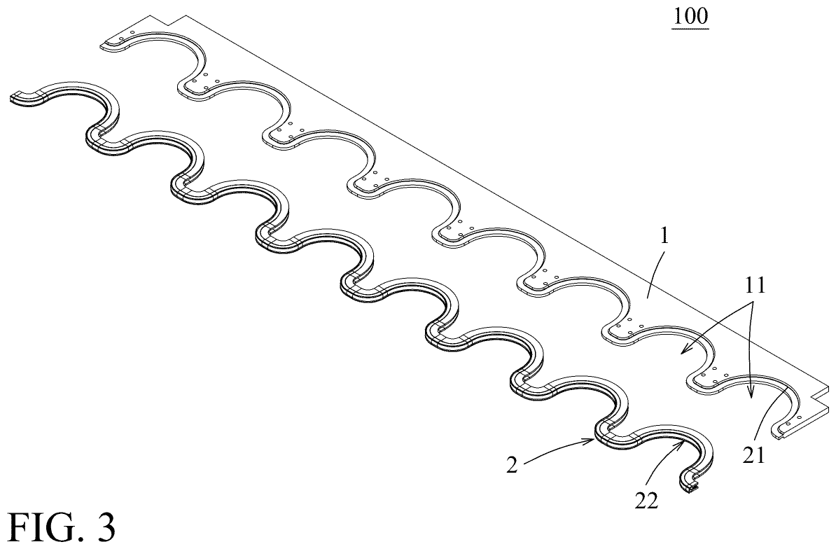

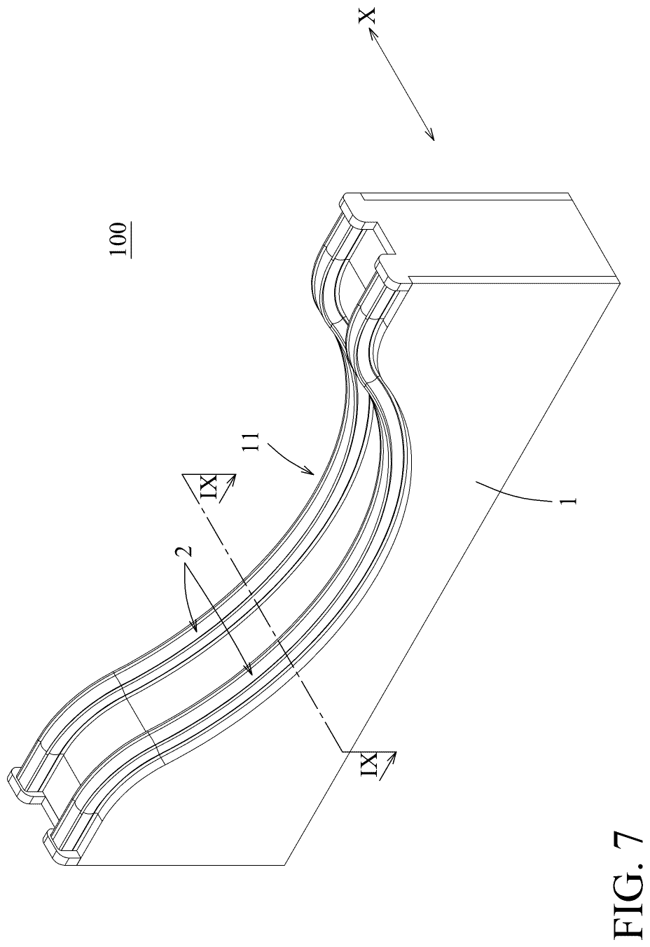

Referring to FIGS. 1 to 3, the shock-absorbing structure 2 includes a connecting member 21 and a shock-absorbing member 22. The connecting member 21 extends in a curving direction that is transverse to the groove-extending direction (X) and protrudes outwardly from a groove defining wall of the base 1 that defines the round groove 11. In this embodiment, the number of the shock-absorbing structure 2 is exemplified as one, and the connecting member 21 is integrally connected to the front side of the base 1 and extends in the curving direction to have a wave shape. However, in some embodiments not shown in the figures, the connecting member 21 may be an arcuate structure including divided multiple segments each of which protrudes outwardly from the groove defining wall of the base 1. Furthermore, the number of the shock-absorbing structure 2 may be plural as shown in FIG. 7, and is not limited to those in the above-stated embodiments.

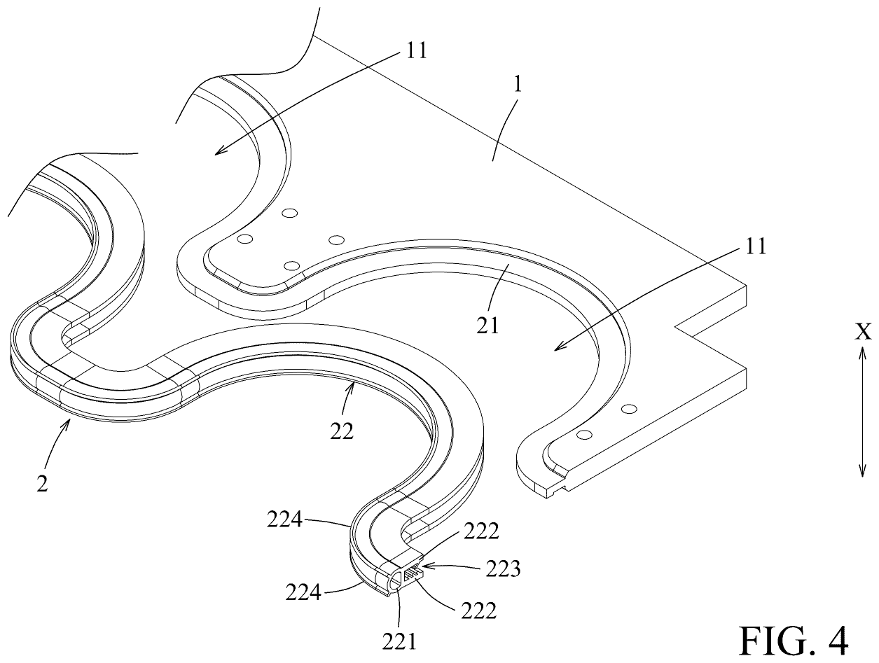

Referring to FIGS. 1 to 4, the shock-absorbing member 22 is, for example, made of rubber, but is not limited thereto. The shock-absorbing member 22 is detachably mounted to the connecting member 21 to separate the base 1 and the furnace tube 9, thereby preventing the furnace tube 9 from being damaged due to collision. Specifically, the shock-absorbing member 22 includes a shock-absorbing strip 221 that is disposed on a side of the connecting member 21 distal from the base 1 and that is adapted for allowing the furnace tube 9 to lean thereagainst, two clamping strips 222 that extend respectively from two opposite sides of the shock-absorbing strip 221 in the groove-extending direction (X), and a plurality of ribs 224 that are connected to one side of the shock-absorbing strip 221 distal from the base 1 and that extend along the shock-absorbing strip 221.

Referring to FIGS. 1 and 3 to 5, the shock-absorbing strip 221 and the clamping strips 222 cooperatively define an insertion groove 223 that allows the connecting member 21 to be removably inserted therein to thereby allow the shock-absorbing member 22 to be stably positioned in the round groove 11. The clamping strips 222 clamp the connecting member 21 via the elastic deformation thereof or via the matching of the shapes between the insertion groove 223 and the connecting member 21, so that the shock-absorbing member 22 may be stably positioned in the round groove 11. In this way, the shock-absorbing member 22 may be stably mounted to one side of the base 1 without using an adhesive, thereby achieving good stability of the shock-absorbing member 22 and allowing easy replacement of the shock-absorbing member 22. In this embodiment, the shock-absorbing member 22 has a wave shape corresponding to the shape of the connecting member 21, so that the shock-absorbing member 22 may be placed into the round groove 11 at a time when assembling, thereby facilitating installation and allowing the shock-absorbing member 22 to be less likely to fall off. Furthermore, in this embodiment, the shock-absorbing strip 221 is hollow and has an elongated shape. In this way, when the furnace tube 9 is shaken and is slightly displaced while leaning against the shock-absorbing strip 221, the shock-absorbing strip 221 may be pressed and deformed to generate a shock absorption effect.

The ribs 224 are spaced apart from one another in the groove-extending direction (X). The ribs 224 may generate friction with the furnace tube 9 along the groove-extending direction (X) so as to prevent displacement of the furnace tube 9 in the groove-extending direction (X). In this embodiment, the number of the ribs 224 is exemplified as two, but is not limited thereto.

In some embodiments, the thickness of the connecting member 21 in the groove-extending direction (X) (i.e., the direction perpendicular to the extending direction of the connecting member 21) is smaller than the thickness of the base 1 in the groove-extending direction (X). In this way, when the shock-absorbing member 22 is detachably mounted to the connecting member 21, one side of each of the clamping strips 222 distal from the shock-absorbing strip 221 abuts against the front side of the base 1, so that, in coordination with the clamping strips 222 respectively abutting against the two opposite sides of the connecting member 21, the shock-absorbing member 22 is restricted and is prevented from moving up and down in a direction toward the base 1, thereby further increasing installation stability of the shock-absorbing member 22.

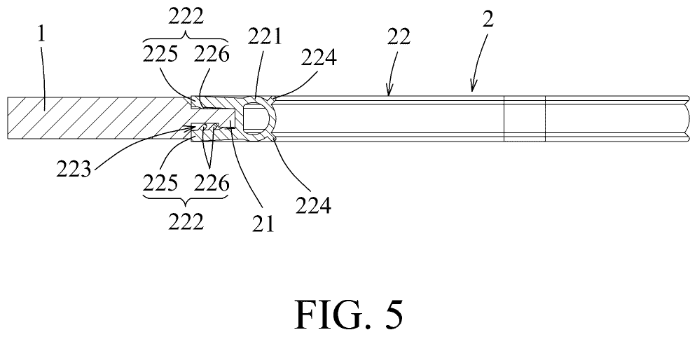

Referring to FIG. 5, in some embodiments, each of the clamping strips 222 has an elongated strip portion 225 and at least one inclined strip portion 226 that is elastically deformable. The elongated strip portions 225 of the clamping strips 222 and the shock-absorbing strip 221 cooperatively define the insertion groove 223. For each of the clamping strips 222, the inclined strip portion 226 extends obliquely from a side of the elongated strip portion 225 adjacent to the connecting member 21 toward the connecting member 21 and the shock-absorbing strip 221. When the connecting member 21 is inserted into the insertion groove 223, the inclined strip portion 226 of each of the clamping strips 222 is pressed by the connecting member 21 to deform so as to fill a gap between the connecting member 21 and the elongated strip portion 225 of each of the clamping strips 222, thereby preventing loosening of the shock-absorbing member 22. In this embodiment, as shown in FIG. 5, the number of the inclined strip portion 226 of one of the clamping strips 222 is exemplified as one, and the number of the inclined strip portion 226 of the other one of the clamping strips 222 is exemplified as three; however, the number of the inclined strip portion 226 of each of the clamping strips 222 is not limited thereto.

In the example of the embodiment, as shown in FIGS. 1 to 5, the furnace tube positioning seat 100 is mounted in the storage cabinet 8 for positioning a plurality of the furnace tubes 9 to be spaced apart from each other in a left-right direction. However, in the another example of the embodiment, as shown in FIGS. 6 to 9, two of the furnace tube positioning seats 100 are mounted in the storage cabinet 8 to be arranged in the rear-front direction, and each of the furnace tube positioning seats 100 is used for positioning only one of the furnace tubes 9, to thereby position the furnace tubes 9 in the storage cabinet 8 so as to allow the furnace tubes 9 to be arranged and spaced apart from each other in the rear-front direction.

Referring to FIGS. 6 to 9, in this example, the structure and the shape of the shock-absorbing member 22 are similar to those of the shock-absorbing member 22 shown in FIGS. 1 to 5. However, in the example shown in FIGS. 6 to 9, the base 1 is configured as an elongated block, and the round groove 11 is formed in a top surface of the base 1 and extends through two opposite lateral sides of the base 1 for allowing at least a portion of the furnace tube 9 to be horizontally received therein. Furthermore, in this example, the furnace tube positioning seat 100 includes two of the shock-absorbing structures 2 spaced apart from each other in the groove-extending direction (X) so as to allow two segments of the furnace tube 9 in a longitudinal direction thereof to lean thereagainst. In this way, as compared to the situation where the furnace tube 9 is positioned vertically, a supported area of the furnace tube 9 may be increased, thereby allowing the furnace tube 9 to be more stably positioned.

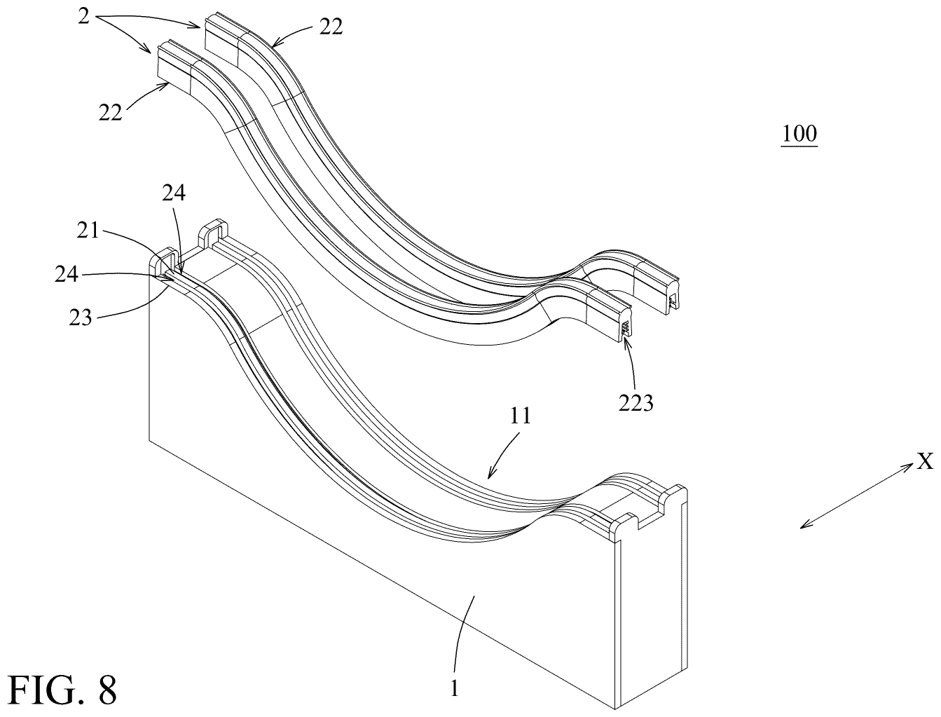

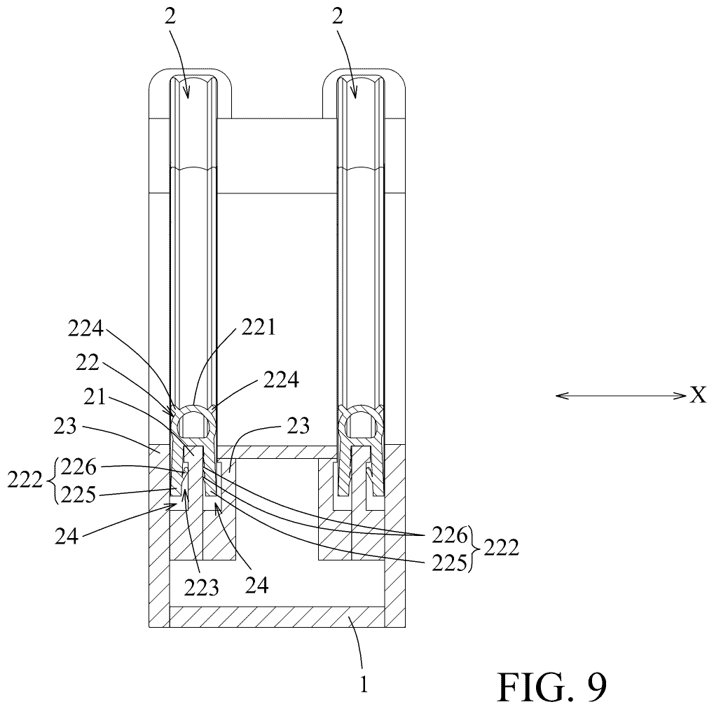

Referring to FIGS. 8 and 9, in this example, each of the shock-absorbing structures 2 further includes two limiting members 23 extending in the curving direction. The limiting members 23 protrude outwardly from the groove defining wall of the base 1 and are respectively located on two opposite sides of the connecting member 21 in the groove-extending direction (X). The limiting members 23 and the connecting member 21 cooperatively define two limiting grooves 24 for allowing the clamping strips 222 to be detachably and respectively inserted therein, so that the clamping strips 222 are restricted by the limiting members 23 and are prevented from moving in the groove-extending direction (X), thereby allowing the shock-absorbing member 22 to be more stably positioned in the round groove 11.

In summary, by virtue of the connecting member 21 and the insertion groove 223 that allow the connecting member 21 to be inserted therein, the shock-absorbing member 22 may be stably mounted to the base 1 and positioned in the round groove 11, so as to be prevented from loosening when an external force is not applied, thereby increasing installation stability of the shock-absorbing member 22, and thus the object of this disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A furnace tube positioning seat adapted for positioning at least one furnace tube, comprising:
a base having at least one round groove that is formed in a surface of said base and that extends through two opposite sides of said base in a groove-extending direction for allowing at least a portion of the furnace tube to be received therein; and
at least one shock-absorbing structure including a connecting member and a shock-absorbing member, said connecting member extending in a curving direction that is transverse to the groove-extending direction and protruding outwardly from a groove defining wall of said base that defines said round groove, said shock-absorbing member including a shock-absorbing strip that is disposed on a side of said connecting member distal from said base and that is adapted for allowing said furnace tube to lean thereagainst, and two clamping strips that extend respectively from two opposite sides of said shock-absorbing strip in the groove-extending direction, said shock-absorbing strip and said clamping strips cooperatively defining an insertion groove that allows said connecting member to be removably inserted therein to thereby allow said shock-absorbing member to be stably positioned in said round groove.

2. The furnace tube positioning seat as claimed in claim 1, wherein a thickness of said connecting member in the groove-extending direction is smaller than a thickness of said base in the groove-extending direction, one side of each of said clamping strips that is distal from said shock-absorbing strip abutting against said base.

3. The furnace tube positioning seat as claimed in claim 1, wherein said shock-absorbing strip is hollow and has an elongated shape.

4. The furnace tube positioning seat as claimed in claim 1, wherein said shock-absorbing member further includes a plurality of ribs that are connected to one side of said shock-absorbing strip distal from said base and that extend along said shock-absorbing strip, said ribs being spaced apart from one another in the groove-extending direction.

5. The furnace tube positioning seat as claimed in claim 1, wherein:
each of said clamping strips has an elongated strip portion and at least one inclined strip portion that is elastically deformable, said elongated strip portions of said clamping strips and said shock-absorbing strip cooperatively defining said insertion groove;
for each of said clamping strips, said inclined strip portion extends obliquely from a side of said elongated strip portion adjacent to said connecting member toward said connecting member and said shock-absorbing strip; and
when said connecting member is inserted into said insertion groove, said inclined strip portion of each of said clamping strips is pressed by said connecting member to deform so as to fill a gap between said connecting member and said elongated strip portion of each of said clamping strips.

6. The furnace tube positioning seat as claimed in claim 1, wherein said shock-absorbing structure further includes two limiting members extending in the curving direction, said limiting members protruding outwardly from said groove defining wall of said base and respectively located on two opposite sides of said connecting member in the groove-extending direction, said limiting members and said connecting member cooperatively defining two limiting grooves for allowing said clamping strips to be detachably and respectively inserted therein.

7. The furnace tube positioning seat as claimed in claim 6, wherein:
said round groove is formed in a top surface of said base and extends through two opposite lateral sides of said base for allowing at least a portion of said furnace tube to be horizontally received therein; and
said furnace tube positioning seat includes two of said shock-absorbing structures spaced apart from each other in the groove-extending direction so as to allow two segments of said furnace tube in a longitudinal direction thereof to lean thereagainst.

8. The furnace tube positioning seat as claimed in claim 1, wherein said round groove is formed in a lateral surface of said base and extends through top and bottom sides of said base for allowing at least a portion of said furnace tube to be vertically received therein.
